(19) United States
(12) Patent Application Publication
(10) Pub. No.: US 2012/0210830 A1
(43) Pub. Date: Aug. 23, 2012

(54) DIMENSION-REDUCING NUT INSERT FOR A HYDRAULIC TORQUE WRENCH

(75) Inventor: Lars-Erik Rundquist, Flen (SE)

(73) Assignee: MOMENTO AB, Flen (SE)

(21) Appl. No.: 13/501,639

(22) PCT Filed: Oct. 12, 2010
(86) PCT No.: PCT/SE2010/000244

§ 371 Date: Apr. 12, 2012

(30) Foreign Application Priority Data
Oct. 12, 2009 (SE) 0901312-9

(51) Int. Cl. B25B 13/58

(52) U.S. Cl. 81/185

(57) ABSTRACT

The present invention relates to a dimension reducing flange equipped nut insert (2) to quickly and safely releasably insertion in a tool head (1) of an hydraulic wrench. The invention is characterized by at least two inserts (3) of a magnetic material intended to, at a mounted position of the insert, come to a close position towards magnetisable portions of the tool head (1) in such a way to allow a magnetic flow between the parts and exert a retaining action between the nut socket insert (2) and the tool head (1).

The present invention relates to a nut insert in a tool head for a quick and safe positioning and attachment in a hydraulic torque wrench.

At power tools for tightening bolted joints interchangeable insert elements for different sizes of nuts are often used for changing into different smaller nut dimensions compared to a stationary and set bigger nut dimension. These reducing nut inserts must quick and easily be connectable to the tool head and safely remain there also during work. The change of a socket increases the risk of dropping it. But also when using the tool there is a risk of loosing the dimension reducing nut insert even if it is secured by a resilient split rings etc, as resilient split rings etc unintentionally may fasten or in some other ways be influenced during the work performance and thereby loosing their locking action why the nut insert may risk to fall out. The mechanic using the tool does not know when this locking action is lost. Bigger nut inserts may weigh up to 500 g, which means that a falling nut insert may cause damages, especially if the tool is used at working places high up as at wind mills, oil platforms and building sites, that is at places where this type of power tools often are used.

It is previously known to arrange a magnetic lock between tool bits and a tool holder. See e.g. DE202009007857 U1 disclosing an attachment of a tool element and where the tool element has a magnetic insert. Also U.S. Pat. No. 5,259,278 discloses a special magnetic ring known to be inserted between a tool head and a nut socket as additional safety when other locks and holder arrangements are failing.

The main object of the present invention is to obtain a dimension reducing nut socket insert for a quick and safe insertion and attachment at a tool head.

An other object is to obtain a nut insert suitable for use at tool heads of different widths and/or thickness.

Yet another object of the present invention is to obtain a dimension reducing nut socket insert allowing that several socket inserts are used at the same time, that is nuts of several smaller dimension steps may be tightened in the one and same tool.

The objects mentioned above have been achieved by an invention having the characterizing clauses mentioned in the claims.

The invention will now be described in connection to an embodiment shown in the drawings, where,

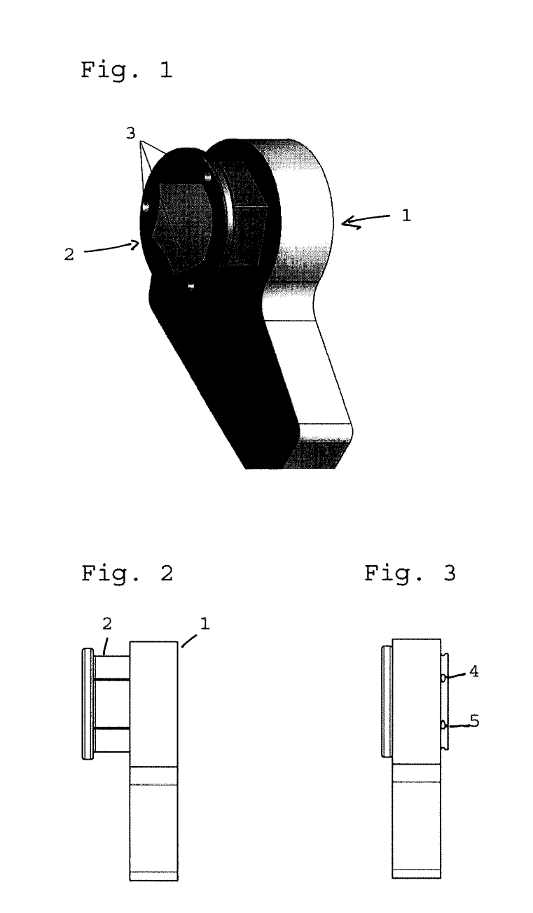

FIG. 1 is a diagrammatic view of a power tool head for mounting and with an insert socket being introduced;

FIG. 2 is a side view of FIG. 1, and where

FIG. 3 is a side view where the insert socket is inserted in a mounted position for use.

The power tool head 1 shown in FIG. 1 is cooperating with a reducing nut socket insert 2. The magnetic flow is obtained from at least two magnetic inserts 3 at a peripheral flange portion of the nut insert 2 which flow exerts a retaining force between the tool head 1 and the nut insert 2, since the tool head is equipped with or consists of a magnetisable material in connection to the mounted nut socket insert 2.

In FIG. 2 a side view of the insertion of the nut socket insert 2 into the tool head 1 is shown. Principally it is possible to also insert a second nut socket insert into the first nut socket insert, which second nut socket insert will have a smaller dimension and its own magnetic inserts. For some smaller dimensions it is possible to also insert a third nut socket insert as more magnetic inserts will strengthen the magnetic retaining force toward the power head.

In FIG. 3 the nut socket insert is shown in a working position. Here withdrawals 4, 5 are shown for conventional split rings, etc which, to work properly, must be placed in direct connection to the tool head. Thus these withdrawals 4 and 5 may not be used if the tool head is too wide or too narrow. By the present invention a retaining action is obtained between the nut socket insert and the tool head without the use of special locking arrangements. For certain use it may be stipulated that mechanical locking means between the nut insert and the tool head shall be used. From this reason these mechanical locking means exist also with nut socket inserts having magnetic locking according to the invention.

Of course it is also possible to arrange the magnetic inserts in the insert body itself to cooperate with magnetic material in the nut socket insert receiving opening of the tool head. Of course, a combination of magnetic inserts both at the flange and at the nut insert body is also possible.

The invention is not restricted to the shown embodiment, but modifications can be made within the scope of the following claims.

1. A dimension reducing flange equipped nut insert (2) to quickly and safely releasably insertion in a tool head (1) of an hydraulic wrench, characterized by at least two inserts (3) of a magnetic material intended to, at a mounted position of the insert, come to a close position towards magnetisable portions of the tool head (1) in such a way to allow a magnetic flow between the parts and exert a retaining action between the nut socket insert (2) and the tool head (1).

2. A nut insert (2) according to claim 1, characterized in that the inserts (3) are at a flange portion at the same time acting as a stop during the mounting of the nut insert (2) to a working position in the tool head (1).

3. A nut insert (2) according to claim 1, characterized in that magnetic inserts are positioned also in the body of the nut insert (2).
